(19) United States
(12) Patent Application Publication
(10) Pub. No.: US 2016/0073312 A1
(43) Pub. Date: Mar. 10, 2016

(54) INTEGRATED IDLE MODE AND ACTIVE MODE TRAFFIC MANAGEMENT

(71) Applicant: Alcatel-Lucent USA Inc., Murray Hill, NJ (US)

(72) Inventor: Kamakshi Sridhar, Plano, TX (US)

(21) Appl. No.: 14/481,773

(22) Filed: Sep. 9, 2014

(51) Int. Cl. H04W 36/22; H04W 36/26; H04W 28/02; H04W 36/00

(52) U.S. Cl. CPC H04W 36/22; H04W 36/0088; H04W 36/26; H04W 28/0289; H04W 28/0284

(57) ABSTRACT

A base station modifies one or more cell reselection parameters for idle user equipment camped on a carrier of the base station in response to changes in a measured load of active user equipment on the carrier. The base station may then transmit the one or more cell reselection parameters.

### BACKGROUND

1. Field of the Disclosure

The present disclosure relates generally to wireless communication systems and, more particularly, to managing loads on a wireless communication system.

2. Description of the Related Art

Congestion in wireless communication systems reduces the quality of service and increases the probability of dropped calls. A carrier of an eNodeB can become congested if too many user equipment in the active mode are attempting to communicate with the eNodeB over the carrier. The wireless communication system may therefore load balance some of the active user equipment away from the heavily loaded carrier to a more lightly loaded carrier to reduce congestion on the heavily loaded carrier. Active mode load-balancing uses inter-frequency hard (i.e., break-before-make) handovers to move the active sessions from the heavily loaded carrier to the more lightly loaded carrier. However, inter-frequency hard handovers are known to have a higher probability of call drops because hard handovers require that the user equipment enter the compressed measurement mode and suspend communication on its current carrier for a short time interval to measure signal strengths on potential target carriers.

Active mode load-balancing is also unable to reduce the latent load on a carrier produced by user equipment in the idle mode that have camped on the carrier. The latent load of idle user equipment may become an actual load as one or more of the idle user equipment transition to the active mode. In some circumstances, the increase in the active load may overwhelm the active mode load-balancing mechanism. For example, the load on a carrier may increase suddenly and dramatically if a large number of idle user equipment transition to the active mode within a short time interval, such as at halftime of a sporting event.

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a method is provided for modifying cell reselection parameters. Some embodiments of the method include modifying, at a base station, one or more cell reselection parameters for idle user equipment camped on a carrier of the base station in response to changes in a measured load of active user equipment on the carrier. Some embodiments of the method also include transmitting the one or more cell reselection parameters from the base station.

In some embodiments, an apparatus is provided for modifying cell reselection parameters. Some embodiments of the apparatus include a base station that has a processor to modify one or more cell reselection parameters for idle user equipment camped on a carrier of the base station in response to changes in a measured load of active user equipment on the carrier. The base station also includes a transceiver to transmit the one or more cell reselection parameters.

In some embodiments, a method is provided for modifying cell reselection parameters. Some embodiments of the method include receiving, at idle user equipment camped on a carrier of a base station, one or more modified cell reselection parameters in response to changes in a measured load of active user equipment on the carrier. The method also includes storing the one or more modified cell reselection parameters at the idle user equipment.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of an example of a wireless communication system according to some embodiments.

FIG. 2 is a plot of active loads on carriers in a wireless communication system according to some embodiments.

FIG. 3 is a plot showing thresholds for triggering measurements of neighbor cell signal strengths according to some embodiments.

FIG. 4 is a plot showing hysteresis and offset values for triggering cell reselection to a neighbor cell according to some embodiments.

FIG. 5 is a flow diagram of a method for modifying cell reselection parameters based on active loads associated with carriers according to some embodiments.

FIG. 6 is a block diagram of an example of a wireless communication system according to some embodiments.

### DETAILED DESCRIPTION

Congestion on a heavily loaded carrier of an eNodeB may be reduced or eliminated by modifying idle mode cell reselection parameters for idle user equipment camped on the carrier in response to changes in a measured load of active user equipment on the carrier. Idle user equipment may receive modified idle mode cell reselection parameters in a message transmitted by the eNodeB and may use the idle mode cell reselection parameters to perform idle mode cell reselections away from the carrier. Idle mode cell reselections may include intra-frequency reselection from a carrier on an eNodeB to the same carrier on a different eNodeB, inter-frequency reselection from the carrier to a different carrier (on the same eNodeB or a different eNodeB), or inter-radio access technology (inter-RAT) reselection from the carrier on the eNodeB to a carrier on another eNodeB that operates according to a different radio access technology. In some embodiments, the idle mode cell reselection parameters include a first threshold that is reduced in response to the measured load exceeding a load threshold. Some embodiments of idle user equipment begin performing intra-frequency signal strength measurements when the received signal strength from the carrier falls below the first threshold. Reducing the first threshold therefore increases the probability that idle user equipment perform cell reselection to camp on a different carrier. The idle mode cell reselection parameters may also include additional thresholds (e.g., to trigger inter-frequency signal strength measurements or inter-RAT signal strength measurements) that may be reduced in response to the measured load exceeding corresponding thresholds in order to increase the probability that idle user equipment perform reselection to camp on a different carrier.

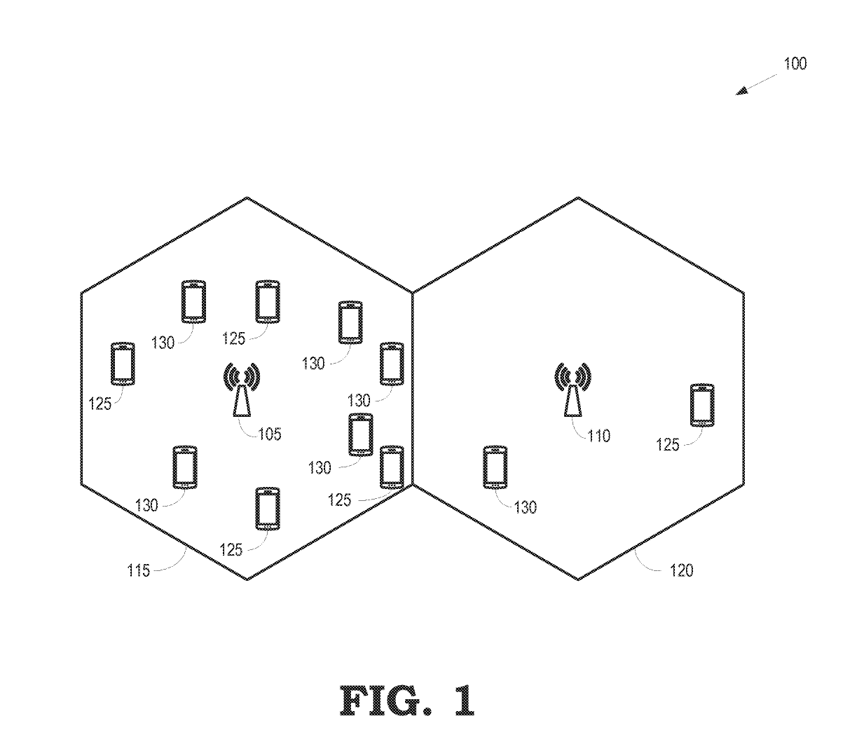

FIG. 1 is a diagram of an example of a wireless communication system 100 according to some embodiments. The wireless communication system 100 includes base stations 105, 110 that provide wireless connectivity in corresponding geographic areas or cells 115, 120. As used herein, the term “base station” will be understood to refer to any device for providing wireless connectivity including eNodeBs, access points, access serving networks, cells, macrocells, microcells, picocells, and the like. In addition to referring to a geographic area, the term “cell” may also be used to refer to the base station 105, 110 that provides wireless connectivity within a geographic area that is also referred to as a cell, such as the cells 115, 120. The base stations 105, 110 may support one or more carriers (or carrier frequencies) and may operate according to standards such as the Long Term Evolution (LTE) standards or the Wideband Code Division Multiple Access (WCDMA) standards defined by the Third Generation Partnership Project (3GPP).

The wireless communication system 100 includes user equipment 125 that are in the active mode. As used herein, the term “active mode” is used to indicate that the user equipment 125 have established a radio bearer with one of the base stations 105, 110 to support communication with the wireless communication system 100 over a corresponding air interface. A user equipment context may be created when a user equipment 125 is turned on and attaches to the network. The context may include user subscription information that is downloaded from a home subscriber server (HSS). The user equipment context may hold dynamic information such as the list of the bearers that are established for the user equipment 125 and the capabilities of the user equipment 125. User equipment 125 in the active mode can hand off a communication session between different base stations 105, 110 in response to changes in the quality of the signals received over the air interface.

Some embodiments of the base stations 105, 110 measure parameters that indicate the active load (or loads) on one or more carriers supported by the base stations 105, 110. For example, the base stations 105, 110 can determine the radio resource status for uplink transmissions or downlink transmissions by measuring the physical resource block (PRB) usage for the active user equipment 125. The base stations 105, 110 may measure the guaranteed bit rate PRB usage for the active user equipment 125 that are receiving a guaranteed bit rate service provided by one of the base stations 105, 110. The base stations 105, 110 may also measure the PRB usage for non-guaranteed bit rate communication with one or more of the active user equipment 125 or the total PRB usage of the active user equipment 125. Information indicative of the measured loads on carriers supported by the base stations 105, 110 may be exchanged between the base stations 105, 110, e.g., via a backplane or backhaul network or interface.

The wireless communication system 100 also includes user equipment 130 that are in the idle mode. As used herein, the term “idle mode” is used to indicate that the user equipment 130 do not have active radio bearers with the base stations 105, 110. The idle mode may also be referred to as a dormant mode, an inactive mode, a sleeping mode, and the like. User equipment 130 can enter the idle mode if the user equipment 130 does not transmit or receive data for a predetermined time interval. In the idle mode, information in the access networks pertaining to the idle user equipment 130, as well as the radio bearers allocated to the idle user equipment 130, can be released, although the wireless communication system 100 may retain the user equipment context for idle user equipment 130 during the idle periods. Minimal control signaling for the idle user equipment 130 contributes a small amount to the load on the base stations 105, 110. Idle user equipment 130 camp on one of the base stations 105, 110 so that they can receive messages such as paging messages from the network via the base station 105, 110. The base station 105, 110 can be selected for camping based on measurements performed by the user equipment 130 such as measurements of a reference signal received power (RSRP) from the base stations 105, 110. Idle user equipment 130 may reselect a different cell for camping in response to changes in the received signal levels from different cells, e.g., due to motion of the user equipment 130 or any other environmental changes that may affect signals as they propagate from the base stations 105, 110 to the user equipment 130. The user equipment 130 can transition from the idle mode to the active mode, e.g., by reestablishing the radio bearers in response to a paging message received over the air interface or in response to a user initiating a call or data session.

Cell reselection may include intra-frequency cell reselection, inter-frequency cell reselection, and inter-radio-access-technology (inter-RAT) cell reselection. As used herein, the term “intra-frequency cell reselection” refers to reselection of an idle user equipment 130 from a first carrier or frequency supported by a first cell to the same first carrier frequency as supported by a second cell. For example, cell reselection from carrier F1 on the base station 105 to the carrier F1 on the base station 110 is referred to as intra-frequency cell reselection. As used herein, the term “inter-frequency cell reselection” refers to reselection of an idle user equipment 130 from a first carrier frequency to a second carrier frequency. For example, cell reselection from carrier F1 (e.g., at 700 MHz) on base station 105 to carrier F2 (e.g., at 1.2 GHz) on either of the base stations 105, 110 is referred to as an inter-frequency cell reselection. As used herein, the term “inter-RAT cell reselection” refers to reselection of an idle user equipment 130 from a first cell that operates according to a first RAT to a second cell that operates according to a second RAT. For example, if the base station 105 operates according to LTE and the base station 110 operates according to WCDMA, cell reselection from the LTE base station 105 to the WCDMA base station 110 would be referred to as inter-RAT cell reselection.

The idle user equipment 130 perform cell reselection based on values of parameters that can be measured or determined by the idle user equipment 130. The parameters may be referred to collectively as cell reselection parameters. In some embodiments, values of the cell reselection parameters may be used to set thresholds for triggering measurements by the idle user equipment 130. The thresholds can be used to choose potential cells for cell reselection. For example, the idle user equipment 130 may measure a parameter related to signal strength such as a RSRP associated with one or more of the base stations 105, 110 or corresponding carriers. A threshold value for triggering measurements of signal strengths of other base stations for potential intra-frequency cell reselection may be equal to a sum of a minimum received signal level for a cell (in LTE, this parameter is referred to as Qrxlevmin) and a parameter for triggering intra-frequency measurements (in LTE, this parameter is referred to as Sintrasearch). For example, measurements of signal strength from neighboring base stations may be performed when:

RSRP<Qrxlevmin+Sintrasearch.

A threshold value for triggering measurements of signal strengths of other base stations for potential inter-frequency cell reselection or inter-RAT cell reselection (collectively referred to herein as “non-intra-frequency cell reselection”) may be equal to a sum of the minimum received signal level and a parameter for triggering non-intra-frequency measurements (in LTE, this parameter is referred to as Snonintrasearch). For example, measurements of signal strength from neighboring base stations may be performed when:

RSRP<Qrxlevmin+Snonintrasearch.

Performing signal strength measurements for non-intra-frequency cell reselection typically requires that the idle user equipment 130 enter the compressed measurement mode, which can increase the probability of dropped calls. The value of the intra-frequency parameter may therefore be larger than the value of the non-intra-frequency parameter.

In some embodiments, values of the cell reselection parameters may be used to set thresholds for triggering cell reselection. For example, the idle user equipment 130 may trigger cell reselection from the base station 105 to the base station 110 based on measurements of the signal strengths of the base stations 105, 110 and values of a hysteresis and an offset associated with the base stations 105, 110 or corresponding carriers. The value of the hysteresis is subtracted from the measured signal strength of the serving cell and the offset is added to the measured signal strength of the neighbor cells. The idle user equipment 130 perform cell reselection to one of the neighbor cells if the signal quality of the neighbor cell exceeds the signal quality of the serving cell by at least the sum of the hysteresis and the offset. For example, a rank (Rs) for the serving cell (such as the base station 105) and a rank (Rn) a neighbor cell (such as the base station 110) may be given by:

Rs=Qmeas,s+Qhyst,s

Rn=Qmeas,n+Qoffset,n

where Qmeas,s and Qmeas,n are measured values of the RSRP for the serving cell and the neighbor cell, respectively, in dB, Qhyst,s is the hysteresis value for the serving cell in dB, and Qoffset,n is the offset value for the neighbor cells in dB. The idle user equipment 130 may perform cell reselection from the base station 105 to the base station 110 if Rn>Rs for a time interval indicated by a parameter T_reselection.

Some embodiments of the base stations 105, 110 can transmit or broadcast messages to the user equipment 130 that indicate modified values of one or more of the cell reselection parameters. The modified values of the cell reselection parameters can be determined in response to a measured active load on a carrier exceeding a load threshold and may be transmitted in messages such as system information blocks (SIBs). The modifications may be determined to increase the probability that the idle user equipment 130 perform cell reselection from carriers that have high active loads (e.g., above the load threshold) to carriers that have lower active loads. For example, if the base station 105 measures an active load from the active user equipment 125 that is above the load threshold, the base station 105 may transmit a message indicating that the idle user equipment 130 is to modify its cell reselection parameters to increase one or more of Qrxlevmin, Sintrasearch, or Snonintrasearch so that the idle user equipment 130 begins performing measurements of neighboring cells at higher measured values of RSRP from the base station 105. For another example, if the base station 105 measures an active load from the active user equipment 125 that is above the load threshold, the base station 105 may transmit a message indicating that the idle user equipment 130 is to modify its cell reselection parameters to decrease one or more of Qhyst associated with the base station 105, Qoffset associated with neighboring base station 110, or T_reselection. Thus, the idle user equipment 130 may trigger cell reselection at smaller differences between signal strength in the serving cell and the neighbor cell, e.g., at smaller values of Qhyst+Qoffset, or after shorter time intervals, e.g. at smaller values of T_reselection.

The modifications of the cell reselection parameters may be determined based on the relative active loadings of the serving cell and the neighboring cells. For example, the potential candidate cells for a cell reselection may be ranked based on the measured RSRP. Values of the hysteresis, offset, or time interval may be modified so that idle user equipment 130 preferentially reselect from the highest-ranking (most heavily loaded) carrier to the lowest-ranked (least heavily loaded) carrier. For example, the hysteresis of the highest ranked carrier may be decreased and the offset of the lowest ranked carrier may also be decreased to encourage cell reselection from the highest ranked carrier to the lowest ranked carrier.

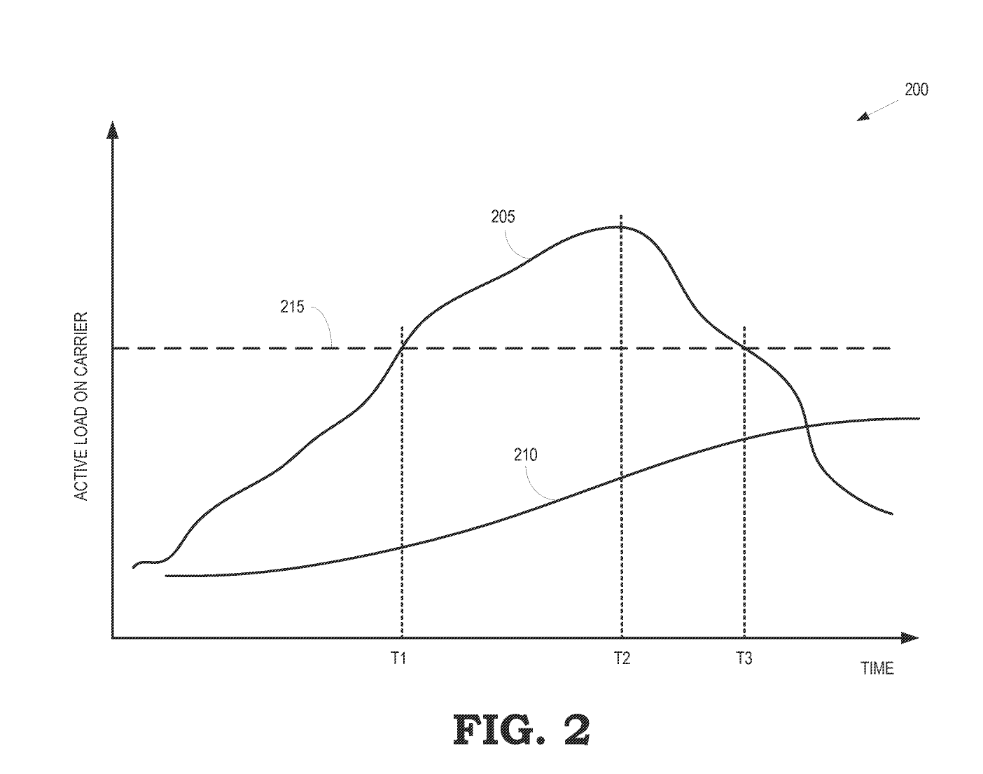

FIG. 2 is a plot 200 of active loads on carriers in a wireless communication system according to some embodiments. The vertical axis indicates the active load on the carrier in arbitrary units and the horizontal axis indicates time increasing from left to right. The active load 205 may represent the load on a first carrier of a cell or base station such as the base station 105 shown in FIG. 1 and the active load 210 may represent the load on a second carrier of a cell or base station such as the base station 110 shown in FIG. 1. As discussed herein, some embodiments of the first and second carriers may have the same frequency (e.g., for intra-frequency cell reselection), a different frequency (e.g., for inter-frequency cell reselection), or may operate according to different RATs (e.g., for inter-RAT cell reselection). The line 215 indicates a load threshold that is used to trigger modification of cell reselection parameters.

At T<T1, the active load 205 and the active load 210 are both below the load threshold 215. There is no need to encourage user equipment to reselect to other cells and consequently the cell reselection parameters are not modified. In some embodiments, the cell reselection parameters may therefore remain at initial or default values.

At T=T1, the active load 205 on the first carrier exceeds the load threshold 215. The cell reselection parameters used by idle user equipment camped on the first carrier may therefore be modified to increase the probability that the idle user equipment perform cell reselection to the second carrier. For example, cell reselection parameters that define thresholds for triggering measurements of signal strengths of neighboring cells may be modified so that idle user equipment begin performing measurements of signal strengths of neighboring cells at lower measured values of signal strength from the serving cell. For another example, cell reselection parameters that define thresholds for triggering cell reselection from the serving cell to a neighboring cell may be modified to increase the probability that idle user equipment perform cell reselection from the serving cell to the neighboring cell. Values of the modified cell reselection parameters may be provided to the user equipment in messages that are broadcast or transmitted over the air interface by the serving cell.

At T1<T<T2, idle user equipment use the modified cell reselection parameters to trigger measurements of signal strengths of neighboring cells or to trigger cell reselection to the second carrier. The active load 205 on the first carrier may continue to increase even though idle user equipment are reselecting to the second carrier. The active load 210 on the second carrier may also increase as idle user equipment reselect to the second carrier and transition to the active mode.

At T2<T<T3, idle user equipment continue to use the modified cell reselection parameters to trigger measurements of signal strengths of neighboring cells or to trigger cell reselection to a neighboring cell. The active load 205 on the first carrier begins to decrease as more idle user equipment reselect to the second carrier and active user equipment on the first carrier hand off to other carriers or transition to the idle mode. The active load 210 on the second carrier may also continue to increase as idle user equipment reselect to the second carrier and transition to the active mode.

At T=T3, the active load 205 on the first carrier falls below the load threshold 215. The cell reselection parameters used by idle user equipment camped on the first carrier may therefore be modified to decrease the probability that the idle user equipment perform cell reselection to the second carrier. For example, cell reselection parameters that define thresholds for triggering measurements of signal strengths of neighboring cells may be modified so that idle user equipment begin performing measurements of signal strengths of neighboring cells at higher measured values of signal strength from the serving cell. For another example, cell reselection parameters that define thresholds for triggering cell reselection from the serving cell to a neighboring cell may be modified to decrease the probability that idle user equipment perform cell reselection from the serving cell to the neighboring cell. Values of the modified cell reselection parameters may be provided to the user equipment in messages that are broadcast or transmitted over the air interface by the serving cell.

At T>T3, the active load 205 and the active load 210 are both below the load threshold 215. There is no need to encourage user equipment to reselect to other cells and consequently the cell reselection parameters are not modified from their previous values. In some embodiments, the cell reselection parameters may be returned to a default or initial set of values of the cell reselection parameters at T>T3.

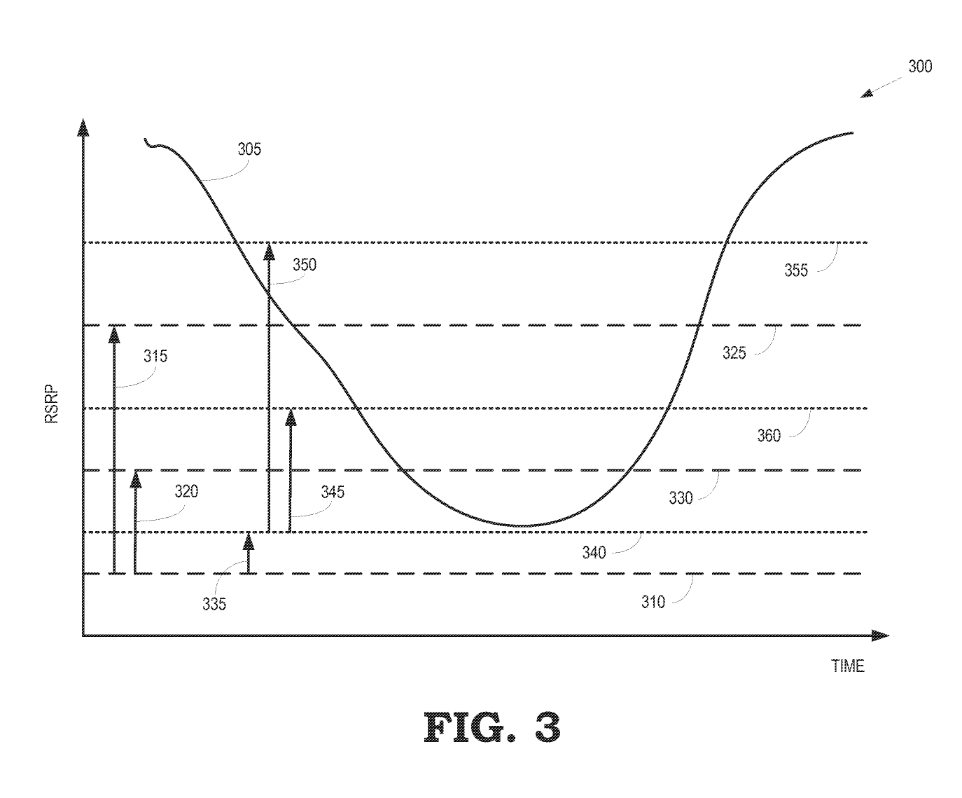

FIG. 3 is a plot 300 showing thresholds for triggering measurements of neighbor cell signal strengths according to some embodiments. The vertical axis indicates a reference signal received power (RSRP) in arbitrary units and the horizontal axis indicates time increasing from left to right. Line 305 indicates a measured value of the RSRP of the serving cell. Dashed line 310 indicates a minimum received signal strength such as Qrxlevmin. Arrows 315, 320 indicate parameters for triggering intra-frequency measurements (such as Sintrasearch) and parameters for triggering non-intra-frequency measurements (such as Snonintrasearch), respectively. The cell reselection parameters parameters 310, 315, 320 are then used to define the thresholds 325, 330 for triggering intra-frequency measurements and non-intra-frequency measurements, respectively.

The cell reselection parameters 310, 315, 320 may be modified to increase the probability that the idle user equipment perform measurements of RSRP for one or more neighbor cells, e.g., to identify candidates for cell reselection. For example, the cell reselection parameter 310 may be increased (as indicated by arrow 335) to increase the minimum received signal strength to the value 340. The cell reselection parameters 315, 320 may also be increased to values indicated by the (longer) arrows 345, 350. In the interest of clarity, the modifications of the cell reselection parameters 310, 315, 320 to the cell reselection parameters 340, 345, 350 are depicted as occurring sequentially. However, the modifications may occur in any order, concurrently, or simultaneously. Furthermore, in some embodiments a subset of the cell reselection parameters 310, 315, 320 may be modified. The modified cell reselection parameters 340, 345, 350 may be used to define modified thresholds 355, 360 for triggering intra-frequency measurements and non-intra-frequency measurements, respectively.

Modifying the cell reselection parameters 310, 315, 320 may result in idle user equipment performing RSRP measurements of neighboring cells under different load conditions (e.g., illustratively in FIG. 3, at earlier times). For example, increasing one or more of the cell reselection parameters 310, 315, 320 to modified values of the cell reselection parameters 340, 345, 350 increases the thresholds 325, 330 to the thresholds 355, 360 for triggering intra-frequency measurements and non-intra-frequency measurements, respectively. The higher values of the thresholds 355, 360 indicate that idle user equipment trigger measurements of the RSRP for neighbor cells at higher values of the serving cell RSRP, which increases the probability that idle user equipment perform the measurements that can be used to select neighboring cells as candidates for cell reselection.

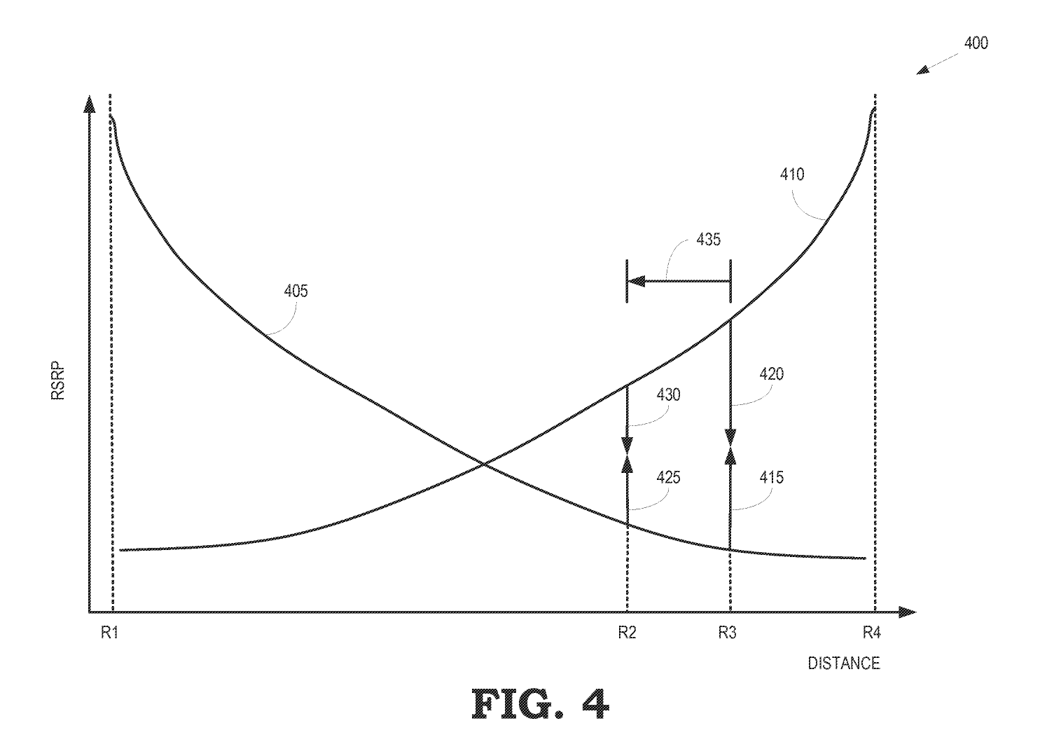

FIG. 4 is a plot 400 showing hysteresis and offset values for triggering cell reselection to a neighbor cell according to some embodiments. The vertical axis indicates a reference signal received power (RSRP) in arbitrary units and the horizontal axis indicates distance in arbitrary units. A base station, such as the base station 105 shown in FIG. 1, is located at distance R1 and a base station, such as the base station 110 shown in FIG. 1, is located at distance R4. Line 405 indicates the RSRP for a reference signal transmitted by the base station located at R1 as a function of distance and line 410 indicates the RSRP for a reference signal transmitted by the base station located at R2 as a function of distance. The base station located at R1 is assigned a hysteresis 415 and the base station located at R4 is assigned an offset 420.

Idle user equipment such as the user equipment 130 shown FIG. 1 measure the RSRPs for the base stations to determine whether to reselect from one base station to another. For example, user equipment located at R3 is camped on the base station located at R1. The user equipment measures the values of the RSRPs 405, 410 at R3. As discussed herein, the user equipment may trigger cell reselection to the base station located at R4 in response to the difference between the measured values of the RSRPs 405, 410 being greater than or equal to the sum of the hysteresis 415 and the offset 420. Otherwise, the user equipment remains camped on the base station located at R1. In some embodiments, cell reselection is triggered if the difference between the measured values of the RSRPs 405, 410 remains greater than or equal to the sum of the hysteresis 415 and the offset 420 for at least a selected time interval.

The hysteresis 415 and the offset 420 may be modified to increase the probability that the idle user equipment performs a cell reselection to the base station located at R4. For example, the hysteresis 415 assigned to the base station located at R1 may be reduced to a hysteresis 425 or the offset 420 assigned to the base station located at R4 may be reduced to an offset 430. Accordingly, user equipment located at R2 may trigger cell reselection to the base station located at R4 in response to the difference between the measured values of the RSRPs 405, 410 being greater than or equal to the sum of the hysteresis 425 and the offset 430. Otherwise, the user equipment remains camped on the base station located at R1. Modifying the hysteresis 415 and the offset 420 may therefore reduce the distance from R1 at which the user equipment triggers reselection to the base station located at R4 by a distance 435. In some embodiments, the selected time interval for performing cell reselection may be reduced so that cell reselection is triggered if the difference between the measured values of the RSRPs 405, 410 remains greater than or equal to the sum of the hysteresis 425 and the offset 430 for a shorter time interval than the time interval associated with the hysteresis 415 and the offset 420.

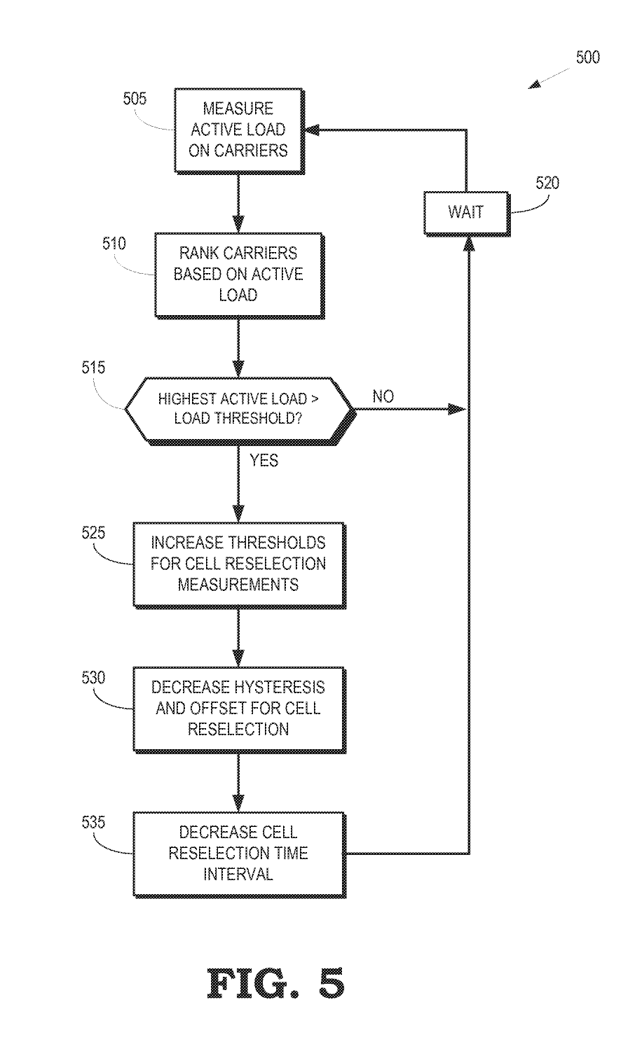

FIG. 5 is a flow diagram of a method 500 for modifying cell reselection parameters based on active loads associated with carriers according to some embodiments. The method 500 may be implemented in some embodiments of the base stations 105, 110 in the wireless communication system 100 shown in FIG. 1. Some embodiments of the method 500 may be implemented in other entities in the wireless communication system, such as base station controllers, radio network controllers, and the like. At block 505, base stations measure active loads on their carriers. For example, base stations can measure loads on carriers F1, F2, . . . , Fn. Information indicating the measured loads may be exchanged between the base stations or with other entities in a wireless communication system such as base station controllers, radio network controllers, and the like. At block 510, the carriers may be ranked based on the measured loads so that carriers that have higher loads get higher rankings At decision block 515, a base station determines whether the highest ranked carrier has an active load that exceeds a load threshold. If not, the base station waits (at block 520) for a predetermined time interval and then performs another measurement of the active loads at block 505.

If the highest ranked carrier has an active load that exceeds the load threshold, cell reselection parameters used by idle user equipment may be modified. For example, base stations may modify their cell reselection parameters and then transmit or broadcast the cell reselection parameters to user equipment, which may use the modified cell reselection parameters for deciding whether to perform measurements of neighboring cells or trigger cell reselection to a neighboring cell or a combination thereof. At block 525, the cell reselection parameters are modified to increase one or more thresholds for performing cell reselection measurements. For example, one or more of the cell reselection parameters Qrxlevmin, Sintrasearch, or Snonintrasearch may be increased to modify the thresholds so as to increase the probability that idle user equipment perform cell reselection measurements. At block 530, the cell reselection parameters are modified to decrease a hysteresis or an offset used to trigger cell reselection from a serving cell to a neighboring cell. At block 535, the cell reselection parameters are modified to decrease pay cell reselection time interval that elapses before triggering cell reselection. The steps 525, 530, 535 may be performed in any order, concurrently, or simultaneously. Some embodiments may not implement all of the steps 525, 530, 535 and may implement subsets of the steps 525, 530, 535.

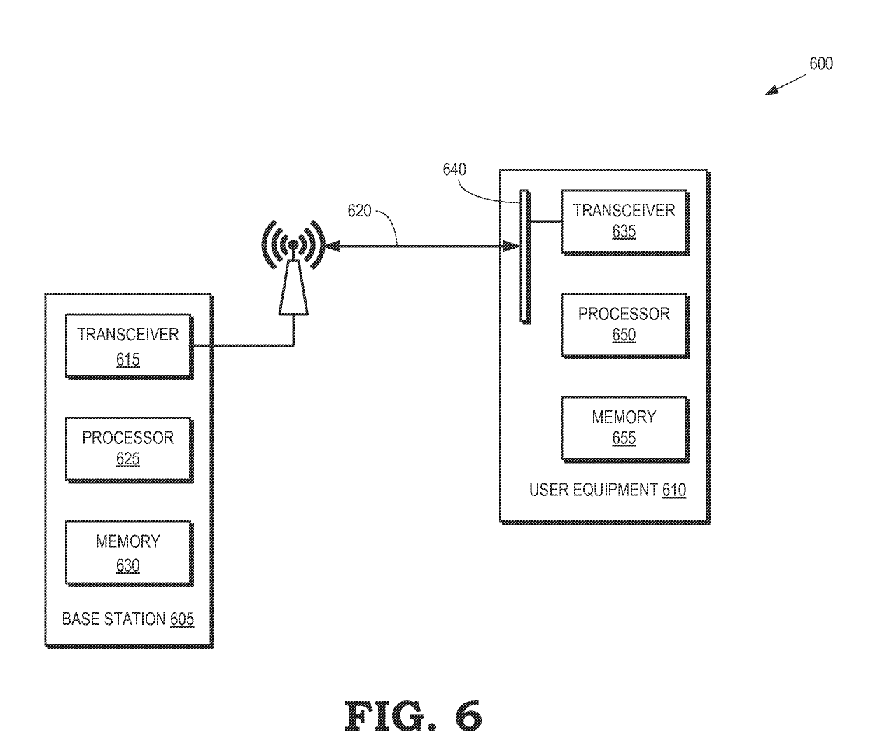

FIG. 6 is a block diagram of an example of a wireless communication system 600 according to some embodiments. The wireless communication system 600 includes a base station 605 and user equipment 610. Some embodiments of the base station 605 and the user equipment 610 may be used to implement one or more of the base stations 105, 110 or the user equipment 125, 130 shown in FIG. 1.

The base station 605 includes a transceiver 615 for transmitting or receiving messages, such as messages transmitted to the user equipment 610 over an air interface 620. The transceiver 615 may support wired or wireless communication. The base station 605 also includes a processor 625 and a memory 630. The processor 625 may be used to execute instructions stored in the memory 630 and to store information in the memory 630 such as the results of the executed instructions. Some embodiments of the transceiver 615, the processor 625, or the memory 630 may be used to implement embodiments of the techniques described herein including the method 500 shown in FIG. 5. For example, the processor 625 may be used to modify cell reselection parameters based on instructions stored in the memory 630, which may also store the modified cell reselection parameters. The transceiver 615 may access the modified cell reselection parameters from the memory 630 and transmit or broadcast messages including the modified cell reselection parameters over the air interface 620 to the user equipment 610.

The user equipment 610 includes a transceiver 635 that is coupled to an antenna 640 for transmitting or receiving messages over the air interface 620, such as messages transmitted by the base station 605. The transceiver 635 may support wired or wireless communication. The user equipment 610 also includes a processor 650 and a memory 655. The processor 650 may be used to execute instructions stored in the memory 655 and to store information in the memory 655 such as the results of the executed instructions. Some embodiments of the transceiver 635, the processor 650, or the memory 655 may be used to implement embodiments of the techniques described herein including a portion of the method 500 shown in FIG. 5. For example, the transceiver 635 may receive messages including modified cell reselection parameters, which may be stored in the memory 655. The processor 650 may then access the modified cell reselection parameters from the memory 655 and use the modified cell reselection parameters to trigger measurements of neighboring cells or trigger cell reselection to a neighboring cell.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
modifying, at a base station, at least one cell reselection parameter for idle user equipment camped on a carrier of the base station in response to changes in a measured load of active user equipment on the carrier; and
transmitting the at least one cell reselection parameter from the base station.

2. The method of claim 1, wherein modifying the at least one cell reselection parameter comprises modifying the at least one cell reselection parameter in response to the measured load exceeding a load threshold.

3. The method of claim 2, wherein modifying the at least one cell reselection parameter comprises increasing at least one threshold for triggering cell reselection measurements by the idle user equipment.

4. The method of claim 3, wherein increasing the at least one threshold for triggering cell reselection measurements comprises increasing at least one of a minimum received signal level for the base station, a threshold for triggering intra-frequency measurements by the idle user equipment, and a threshold for triggering inter-frequency measurements or inter-radio-access-technology measurements by the idle user equipment.

5. The method of claim 2, wherein modifying the at least one cell reselection parameter comprises decreasing a hysteresis applied to signals received from the base station, wherein the hysteresis is used to trigger cell reselection by the idle user equipment from the base station to a neighboring base station.

6. The method of claim 2, wherein modifying the at least one cell reselection parameter comprises decreasing an offset applied to signals received from the neighboring base station, wherein the offset is used to trigger cell reselection by the idle user equipment from the base station to a neighboring base station.

7. The method of claim 2, wherein modifying the at least one cell reselection parameter comprises decreasing a cell reselection time interval that elapses before triggering cell reselection from the base station to a neighboring base station.

8. The method of claim 1, further comprising:
ranking a plurality of carriers of the base station based on measured loads of active user equipment on the plurality of carriers, and wherein modifying the at least one cell reselection parameter comprises modifying the at least one cell reselection parameter based on the ranking of the plurality of carriers.

9. A base station comprising:
a processor configured to modify at least one cell reselection parameter for idle user equipment camped on a carrier of the base station in response to changes in a measured load of active user equipment on the carrier; and
a transceiver configured to transmit the at least one cell reselection parameter.

10. The base station of claim 9, wherein the processor is configured to modify the at least one cell reselection parameter in response to the measured load exceeding a load threshold.

11. The base station of claim 10, wherein the processor configured is to modify the at least one cell reselection parameter by increasing at least one threshold for triggering cell reselection measurements by the idle user equipment.

12. The base station of claim 11, wherein the processor is configured to modify the at least one cell reselection parameter by increasing at least one of a threshold indicating a minimum received signal level for the base station, a threshold for triggering intra-frequency measurements by the idle user equipment, and a threshold for triggering inter-frequency measurements or inter-radio-access-technology measurements by the idle user equipment.

13. The base station of claim 10, wherein the processor is configured to modify the at least one cell reselection parameter by decreasing a hysteresis applied to signals received from the base station, wherein the hysteresis is used to trigger cell reselection by the idle user equipment from the base station to a neighboring base station.

14. The base station of claim 10, wherein the processor is configured to modify the at least one cell reselection parameter by decreasing an offset applied to signals received from the neighboring base station, wherein the offset is used to trigger cell reselection by the idle user equipment from the base station to a neighboring base station.

15. The base station of claim 10, wherein the processor is configured to modify the at least one cell reselection parameter by decreasing a cell reselection time interval that elapses before triggering cell reselection from the base station to a neighboring base station.

16. The base station of claim 9, wherein the processor is configured to rank a plurality of carriers of the base station based on measured loads of active user equipment on the plurality of carriers, and wherein the processor is to modify the at least one cell reselection parameter based on the ranking of the plurality of carriers.

17. A method comprising:
receiving, at idle user equipment camped on a carrier of a base station, at least one modified cell reselection parameter in response to changes in a measured load of active user equipment on the carrier; and
storing the modified cell reselection parameter at the idle user equipment.

18. The method of claim 17, wherein receiving the at least one modified cell reselection parameter comprises receiving at least one increased threshold for triggering cell reselection measurements by the idle user equipment.

19. The method of claim 17, wherein receiving the at least one modified cell reselection parameter comprises receiving at least one of a decreased hysteresis applied to signals received from the base station, a decreased offset applied to signals received from a neighboring base station, and a decreased cell reselection time interval that elapses before triggering cell reselection from the base station to the neighboring base station, and wherein the decreased hysteresis and the decreased offset are used to trigger cell reselection by the idle user equipment from the base station to the neighboring base station.

20. The method of claim 17, further comprising:
determining whether to perform cell reselection based on the at least one cell reselection parameter.
